(19) United States
(12) Patent Application Publication
(10) Pub. No.: US 2008/0225792 A1
(43) Pub. Date: Sep. 18, 2008

(54) MULTIPLEXING OF FEEDBACK CHANNELS IN A WIRELESS COMMUNICATION SYSTEM

(75) Inventors: Ayman Fawzy Naguib, Cupertino, CA (US); Tingfang Ji, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/044,844

(22) Filed: Mar. 7, 2008

Related U.S. Application Data
(60) Provisional application No. 60/894,378, filed on Mar. 12, 2007.

(51) Int. Cl. H04Q 7/00

(52) U.S. Cl. 370/330

(57) ABSTRACT

Techniques for sending signaling in a wireless communication system are described. Multiple feedback channels may be multiplexed such that they can share time frequency resources. Each feedback channel may be allocated a different subset of subcarriers in each of at least one tile. In one design, a subscriber station may determine time frequency resources including first and second portions of time frequency resources for first and second feedback channels, respectively. The subscriber station may send vectors of modulation symbols of a first length on the first feedback channel and/or vectors of modulation symbols of a second length on the second feedback channel. A base station may receive the first and second feedback channels and may perform detection on vectors of received symbols for each feedback channel to recover the signaling sent on that feedback channel.

The present application claims priority to provisional U.S. Application Ser. No. 60/894,378, entitled “EFFICIENT MULTIPLEXING OF PRIMARY AND SECONDARY FAST FEEDBACK CHANNELS IN A WIRELESS COMMUNICATION SYSTEM,” filed Mar. 12, 2007, assigned to the assignee hereof and incorporated herein by reference.

### BACKGROUND

I. Field

The present disclosure relates generally to communication, and more specifically to techniques for sending signaling in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include any number of base stations that can support communication for any number of subscriber stations on the downlink and uplink. The downlink (or forward link) refers to the communication link from the base stations to the subscriber stations, and the uplink (or reverse link) refers to the communication link from the subscriber stations to the base stations. The system may utilize various feedback channels to send signaling. The signaling is beneficial but represents overhead in the system.

There is therefore a need in the art for techniques to efficiently send signaling in a wireless communication system.

### SUMMARY

Techniques for efficiently sending signaling in a wireless communication system are described herein. In an aspect, multiple feedback channels may be multiplexed such that they can share time frequency resources. The time frequency resources may comprise at least one tile, with each tile comprising at least one subcarrier in each of at least one symbol period. Each feedback channel may be allocated a different subset of subcarriers in each tile.

In one design, a subscriber station may determine (e.g., via an assignment message) time frequency resources comprising a first portion of time frequency resources for a first feedback channel and a second portion of time frequency resources for a second feedback channel. The first and second portions of time frequency resources may comprise first and second disjoint subsets of subcarriers, respectively, in each of at least one tile. The subscriber station may send signaling on the first feedback channel using the first portion of time frequency resources and/or on the second feedback channel using the second portion of time frequency resources. The subscriber station may send vectors of modulation symbols of a first length on the first portion of time frequency resources for the first feedback channel. Alternatively or additionally, the subscriber station may send vectors of modulation symbols of a second length on the second portion of time frequency resources for the second feedback channel.

In one design, a base station may receive the first and second feedback channels on the first and second portions of time frequency resources, respectively. The base station may obtain vectors of received symbols of the first length for the first feedback channel and may obtain vectors of received symbols of the second length for the second feedback channel. The base station may perform detection on the vectors of received symbols for the first feedback channel based on a first set of vectors of modulation symbols usable for the first feedback channel. The base station may also perform detection on the vectors of received symbols for the second feedback channel based on a second set of vectors of modulation symbols usable for the second feedback channel.

Various aspects and features of the disclosure are described in further detail below.

### BRIEF DESCRIPTION OF THE DRAWINGS

FIG. 1 shows a wireless communication system.

FIG. 2 shows a subcarrier structure for partial usage of subcarriers (PUSC).

FIG. 3 shows a tile structure for PUSC.

FIG. 4A shows a tile structure for a primary fast feedback channel.

FIG. 4B shows a tile structure for a secondary fast feedback channel.

FIG. 5 shows a tile structure for multiplexing the primary and secondary fast feedback channels.

FIG. 6 shows a QPSK signal constellation.

FIG. 7 shows a process for sending signaling.

FIG. 8 shows an apparatus for sending signaling.

FIG. 9 shows a process for receiving signaling.

FIG. 10 shows an apparatus for receiving signaling.

FIG. 11 shows a block diagram of two subscriber stations and a base station.

### DETAILED DESCRIPTION

The techniques described herein may be used for various wireless communication systems such as CDMA, TDMA, FDMA, OFDMA and SC-FDMA systems. The techniques may also be used for systems that support spatial division multiple access (SDMA), multiple-input multiple-output (MIMO), etc. The terms “system” and “network” are often used interchangeably. An OFDMA system may implement a radio technology such as Ultra Mobile Broadband (UMB), Evolved Universal Terrestrial Radio Access (E-UTRA), IEEE 802.20, IEEE 802.16 (which is also referred to as WiMAX), IEEE 802.11 (which is also referred to as Wi-Fi), Flash-OFDM®, etc. These various radio technologies and standards are known in the art.

For clarity, various aspects of the techniques are described below for WiMAX, which is covered in IEEE 802.16, entitled “Part 16: Air Interface for Fixed and Mobile Broadband Wireless Access Systems,” dated Oct. 1, 2004, and in IEEE 802.16e, entitled “Part 16: Air Interface for Fixed and Mobile Broadband Wireless Access Systems; Amendment 2: Physical and Medium Access Control Layers for Combined Fixed and Mobile Operation in Licensed Bands,” dated Feb. 28, 2006. These documents are publicly available. The techniques may also be used for IEEE 802.16m, which is a new air interface being developed for WiMAX.

The techniques described herein may be used to send signaling on the uplink as well as the downlink. For clarity, various aspects of the techniques are described below for sending signaling on the uplink.

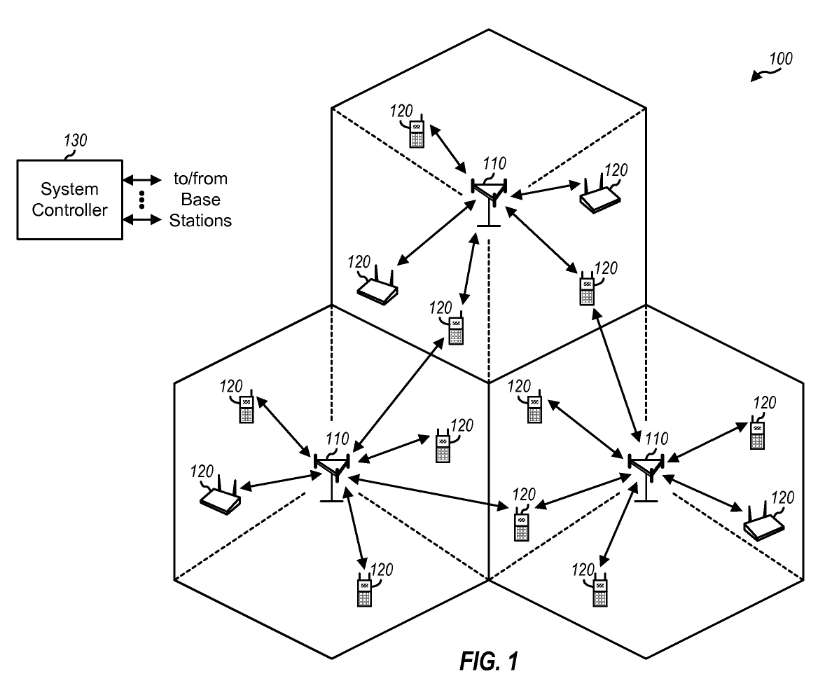

FIG. 1 shows a wireless communication system 100 with multiple base stations (BS) 110 and multiple subscriber station (SS) 120. A base station is a station that supports communication for subscriber stations and may perform functions such as connectivity, management, and control of subscriber stations. A base station may also be referred to as a Node B, an evolved Node B, an access point, etc. A system controller 130 may couple to base stations 110 and provide coordination and control for these base stations.

Subscriber stations 120 may be dispersed throughout the system, and each subscriber station may be stationary or mobile. A subscriber station is a device that can communicate with a base station. A subscriber station may also be referred to as a mobile station, a terminal, an access terminal, a user equipment, a subscriber unit, a station, etc. A subscriber station may be a cellular phone, a personal digital assistant (PDA), a wireless device, a wireless modem, a handheld device, a laptop computer, a cordless phone, etc.

IEEE 802.16 utilizes orthogonal frequency division multiplexing (OFDM) for the downlink and uplink. OFDM partitions the system bandwidth into multiple (N_{FFT}) orthogonal subcarriers, which may also be referred to as tones, bins, etc. Each subcarrier may be modulated with data or pilot. The number of subcarriers may be dependent on the system bandwidth as well as the spacing between adjacent subcarriers. For example, N_{FFT} may be equal to 128, 256, 512, 1024 or 2048. Only a subset of the N_{FFT} total subcarriers may be usable for transmission of data and pilot, and the remaining subcarriers may serve as guard subcarriers to allow the system to meet spectral mask requirements. In the following description, a data subcarrier is a subcarrier used for data, and a pilot subcarrier is a subcarrier used for pilot. An OFDM symbol may be transmitted in each OFDM symbol period (or simply, a symbol period). Each OFDM symbol may include data subcarriers used to send data, pilot subcarriers used to send pilot, and guard subcarriers not used for data or pilot.

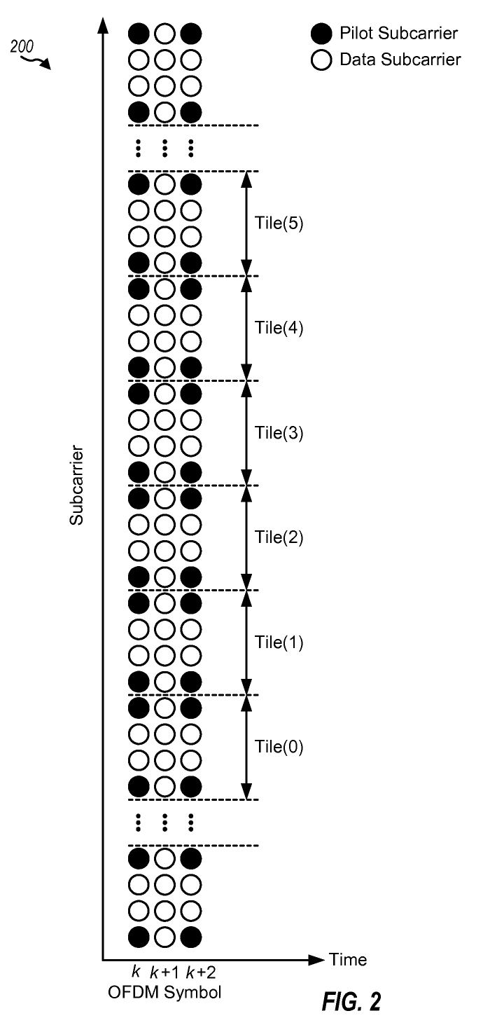

FIG. 2 shows a subcarrier structure 200 for PUSC on the uplink in IEEE 802.16. The usable subcarriers may be divided into Nₜᵢₗₑₛ tiles. Each tile may cover four subcarriers in each of three OFDM symbols and may include a total of 12 subcarriers.

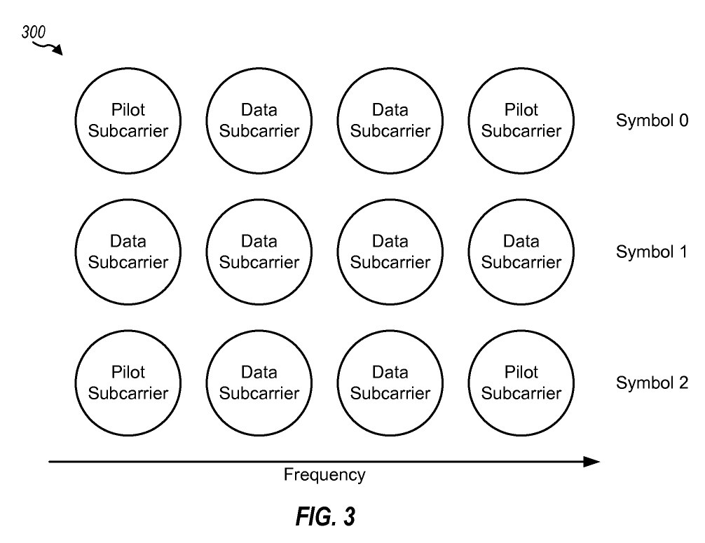

FIG. 3 shows a tile structure 300 used to send data and pilot on the uplink in IEEE 802.16. In structure 300, a tile includes four pilot subcarriers at four corners of the tile and eight data subcarriers at eight remaining locations of the tile. A data modulation symbol may be sent on each data subcarrier, and a pilot modulation symbol may be sent on each pilot subcarrier.

Fast feedback channels may be defined and used to carry various types of signaling such as channel quality information (CQI), acknowledgement (ACK), MIMO mode, MIMO coefficients, etc. The fast feedback channels may be allocated uplink slots, which may also be referred to as fast feedback slots. An uplink slot may include six tiles labeled as Tile(0) through Tile(5), as shown in FIG. 2. In general, the six tiles of one uplink slot may be adjacent to one another (as shown in FIG. 2) or distributed across the system bandwidth (not shown in FIG. 2).

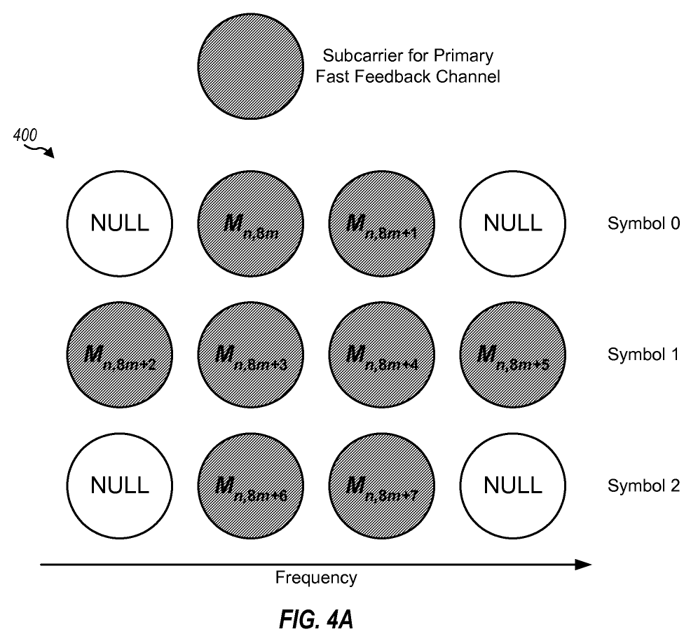

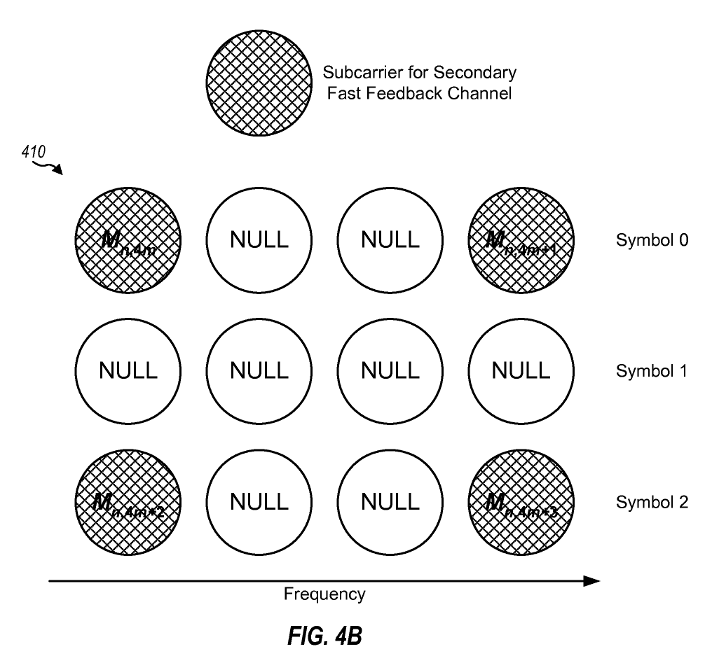

FIG. 4A shows a tile structure 400 that may be used for a primary fast feedback channel. A vector of eight modulation symbols may be sent on eight subcarriers in a tile, as shown in FIG. 4A. These eight subcarriers correspond to the data subcarriers in the tile shown in FIG. 3. The eight modulation symbols sent in the tile are given indices of M_{n,8m+k}, for 0≦k≦7, where n is an index for a fast feedback channel, m is an index for a tile, and k is an index for a modulation symbol sent in the tile. Thus, M_{n,8m+k} is the modulation symbol index for the k-th modulation symbol in the m-th tile of the n-th fast feedback channel. No symbols are sent on the four subcarriers at the four corners of the tile, which correspond to the four pilot subcarriers in FIG. 3.

FIG. 4B shows a tile structure 410 that may be used for a secondary fast feedback channel. A vector of four modulation symbols may be sent on four subcarriers in a tile, as shown in FIG. 4B. These four subcarriers correspond to the pilot subcarriers in the tile shown in FIG. 3. The four modulation symbols sent in the tile are given indices of M_{n,4m+k}, for 0≦k≦3, where n, m and k are defined above. No symbols are sent on the eight remaining subcarriers in the tile, which correspond to the eight data subcarriers in FIG. 3.

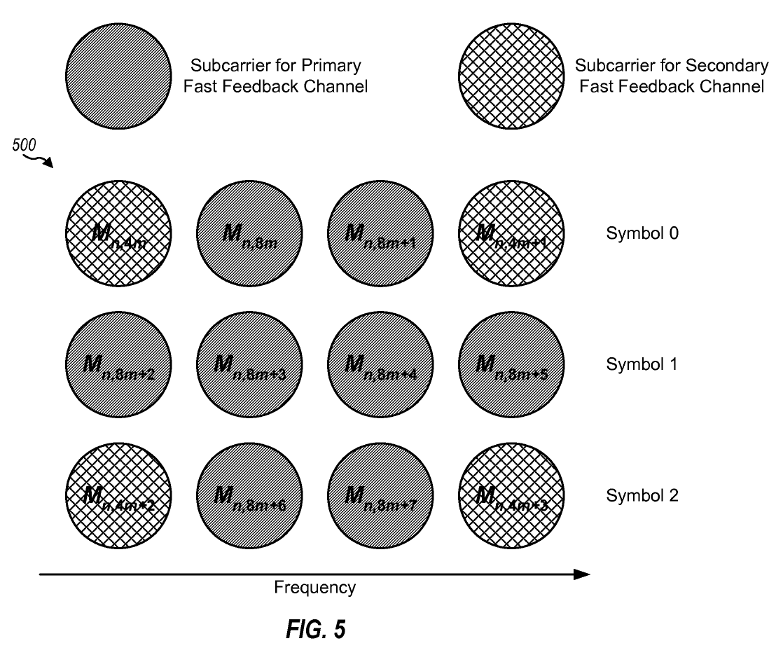

FIG. 5 shows a design of a tile structure 500 that may be used to multiplex the primary and secondary fast feedback channels on the same tile in order to share time frequency resources. Time frequency resources may also be referred to as transmission resources, signaling resources, radio resources, etc. In this design, the primary fast feedback channel is allocated eight subcarriers in a tile, which correspond to the eight data subcarriers in FIG. 3. The secondary fast feedback channel is allocated four subcarriers at the four corners of the tile, which correspond to the four pilot subcarriers in FIG. 3. The primary and secondary fast feedback channels are thus allocated two disjoint subsets of subcarriers in the same tile and may be sent simultaneously without interfering one another.

FIG. 5 shows one design of multiplexing the primary and secondary fast feedback channels on the same tile. In general, each fast feedback channel may be allocated any number of subcarriers and any one of the subcarriers in a tile. More than two fast feedback channels may also be multiplexed on the same tile. Each fast feedback channel may be allocated a different subset of subcarriers in the tile. The fast feedback channels multiplexed on the same tile may be allocated the same or different numbers of subcarriers.

In one design, a single subscriber station may send signaling on both the primary and secondary fast feedback channels on the same tile. This may allow the subscriber station to send more signaling on the time frequency resources allocated for these fast feedback channels.

In another design, two subscriber stations may share the same tile. One subscriber station may send signaling on the primary fast feedback channel on one part of the tile, and another subscriber station may send signaling on the secondary fast feedback channel on another part of the tile. This multiplexing may allow the two subscriber stations to share and more fully utilize the time frequency resources.

The primary and secondary fast feedback channels may both be sent on one uplink slot, which may comprise six tiles. Each tile may include eight subcarriers for the primary fast feedback channel and four subcarriers for the secondary fast feedback channel, as shown in FIG. 5. In each tile, one vector of eight modulation symbols may be sent on the eight subcarriers for the primary fast feedback channel, and one vector of four modulation symbols may be sent on the four subcarriers for the secondary fast feedback channel. Each modulation symbol may be sent on a different subcarrier.

For the primary fast feedback channel, eight orthogonal vectors v₀ through v₇ may be formed. Each vector may include eight modulation symbols and may be expressed as:

vᵢ=[P_{i,0}P_{i,1}P_{i,2}P_{i,3}P_{i,4}P_{i,5}P_{i,6}P_{i,7}]^{T}, for i=0, . . . , 7, Eq (1)

where
P_{i,k} is the k-th modulation symbol in 8-element vector vᵢ, and
“^{T}” denotes a transpose.

The eight vectors v₀ through v₇ are orthogonal to one another, so that

∥vᵢ^{H}vₗ∥=0, for 0≦i≦7, 0≦l≦7 and i≠l, Eq (2)

where “^{H}” denotes a conjugate transpose.

For the secondary fast feedback channel, four orthogonal vectors w₀ through w₃ may be formed. Each vector may include four modulation symbols and may be expressed as:

wⱼ=[P_{j,0}P_{j,1}P_{j,2}P_{j,3}]^{T}, for j=0, . . . , 3, Eq (3)

where P_{j,k} is the k-th modulation symbol in 4-element vector wⱼ.

The four vectors w₀ through w₃ are orthogonal to one another, so that

∥wⱼ^{H}wₗ∥=0, for 0≦j≦3, 0≦l≦3, and j≠l. Eq (4)

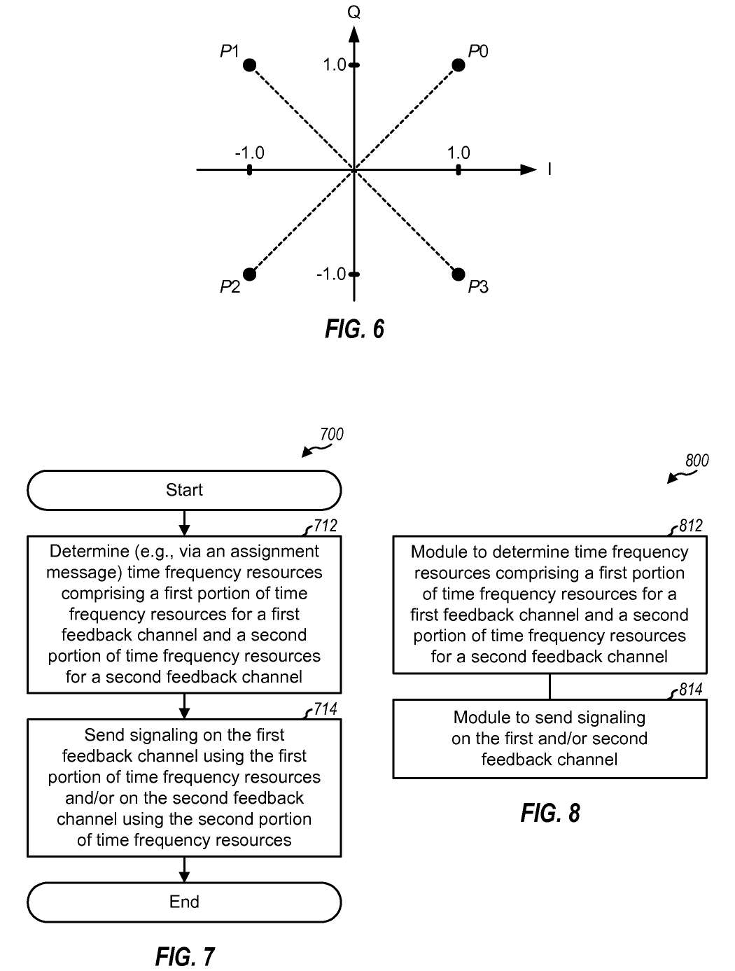

FIG. 6 shows an example signal constellation for QPSK, which is used in IEEE 802.16. This signal constellation includes four signal points corresponding to four possible modulation symbols for QPSK. Each modulation symbol is a complex value of the form xᵢ+jx_{q}, where xᵢ is a real component and x_{q} is an imaginary component. The real component xᵢ may have a value of either +1.0 or −1.0, and the imaginary component x_{q} may also have a value of either +1.0 or −−1.0. The four modulation symbols are denoted as P0, P1, P2 and P3.

The eight vectors v₀ through v₇ may be formed with eight different permutations of QPSK modulation symbols P0, P1, P2 and P3, where P_{i,k}ε{P0, P1, P2, P3}. Similarly, the four vectors w₀ through w₃ may be formed with four different permutations of QPSK modulation symbols P0, P1, P2 and P3, where P_{j,k}ε{P1, P2, P3}. The first two columns of Table 1 give the eight modulation symbols in each of the eight vectors v₀ through v₇, in accordance with one design. The last two columns of Table 1 give the four modulation symbols in each of the four vectors w₀ through w₃, in accordance with one design. Vectors v₀ through v₇ and vectors w₀ through w₃ may also be formed in other manners.

TABLE 1

| Vector | Modulation Symbols | Vector | Modulation Symbols |
|---|---|---|---|
| Index i | in Vector vᵢ | Index j | in Vector wⱼ |
| 0 | P0, P1, P2, P3, P0, P1, P2, P3 | 0 | P0, P0, P0, P0 |
| 1 | P0, P3, P2, P1, P0, P3, P2, P1 | 1 | P0, P2, P0, P2 |
| 2 | P0, P0, P1, P1, P2, P2, P3, P3 | 2 | P0, P1, P2, P3 |
| 3 | P0, P0, P3, P3, P2, P2, P1, P1 | 3 | P1, P0, P3, P2 |
| 4 | P0, P0, P0, P0, P0, P0, P0, P0 | | |
| 5 | P0, P2, P0, P2, P0, P2, P0, P2 | | |
| 6 | P0, P2, P0, P2, P2, P0, P2, P0 | | |
| 7 | P0, P2, P2, P0, P2, P0, P0, P2 | | |

A signaling message for the primary fast feedback channel may be mapped to a set of 8-element vectors, and this set of 8-element vectors may be sent to convey the message. For example, a 4-bit message or a 6-bit message may be mapped to a set of six 8-element vectors, and each 8-element vector may be sent on 8 subcarriers in one tile for the primary fast feedback channel. An example mapping of a 4-bit message to a set of six 8-element vectors and an example mapping of a 6-bit message to a set of six 8-element vectors are described in the aforementioned IEEE 802.16 documents.

A signaling message for the secondary fast feedback channel may be mapped to a set of 4-element vectors, and this set of 4-element vectors may be sent to convey the message. For example, a 4-bit message may be mapped to a set of six 4-element vectors, and each 4-element vector may be sent on 4 subcarriers in one tile for the secondary fast feedback channel. An example mapping of a 4-bit message to a set of six 4-element vectors is described in the aforementioned IEEE 802.16 documents.

One or two subscriber stations may send signaling messages on the primary and secondary fast feedback channels on tiles shared by these fast feedback channels. A base station may obtain 12 received symbols from the 12 subcarriers in each tile. The base station may demultiplex the 12 received symbols from each tile m to obtain (i) a vector r_{m,p} of eight received symbols from the eight subcarriers for the primary fast feedback channel and (ii) a vector r_{m,s} of four received symbols from the four subcarriers for the secondary fast feedback channel. The base station may perform non-coherent detection on vectors r_{m,p} and r_{m,s} to determine the vectors vₘ and wₘ sent on the primary and secondary fast feedback channels. Non-coherent detection refers to detection without the aid of a pilot reference.

In one design, the base station may perform non-coherent detection for the primary fast feedback channel by correlating received vector r_{m,p} for each tile m against each of the eight possible vectors v₀ through v₇, as follows:

M_{m,i}=∥vₗ^{H}r_{m,p}∥, for i=0, . . . , 7, Eq (5)

where M_{m,i} is a correlation result for vector vᵢ in tile m.

For each tile m, the base station may identify the vector with the largest correlation result, as follows:

$${d}_{m} = arg ( {Max}_{i = 0 , … , 7} \{ {M}_{m , i} \} ) . \qquad Eq ( 6 )$$

For each tile m, the base station may determine that vector v_{m,d} was sent in tile m for the primary fast feedback channel based on the received vector r_{m,p} for tile m. The base station may obtain a set of six detected vectors v_{0,d} through v_{5,d} for all six tiles used for the primary fast feedback channel and may determine the message sent on the primary fast feedback channel based on this set of six detected vectors.

In one design, the base station may perform non-coherent detection for the secondary fast feedback channel by correlating received vector r_{m,s} for each tile m against each of the four possible vectors w₀ through w₃, as follows:

M_{m,j}=∥wⱼ^{H}r_{m,s}∥, for j=0, . . . , 3, Eq (7)

where M_{m,j} is a correlation result for vector wⱼ in tile m.

For each tile m, the base station may identify the vector with the largest correlation result, as follows:

$${e}_{m} = arg ( {Max}_{i = 0 , … , 3} \{ {M}_{m , j} \} ) . \qquad Eq ( 8 )$$

For each tile m, the base station may determine that vector w_{m,e} was sent in tile m for the secondary fast feedback channel based on the received vector r_{m,s} for tile m. The base station may obtain a set of six detected vectors w_{0,e} through w_{5,e} for all six tiles used for the secondary fast feedback channel and may determine the message sent on the secondary fast feedback channel based on this set of six detected vectors.

In another design, the base station may perform non-coherent detection for the primary fast feedback channel as follows:

$${A}_{c} = {\sum }_{m = 0}^{5} {G}_{m} \cdot ‖ {\underline{v}}_{m , c}^{H} {\underline{r}}_{m , p} ‖ , \qquad Eq ( 9 )$$

where

v_{m,c} is a vector to send in tile m for message c,

Gₘ is a scaling factor for tile m, and

A_{c} is a metric for message c on the primary fast feedback channel.

In the design shown in equation (9), the base station may correlate the set of six received vectors for six tiles used for the primary fast feedback channel against a set of six vectors for each possible message that can be sent on the primary fast feedback channel. The base station may select the message with the best metric A_{c} as the message that was received on the primary fast feedback channel. The base station may perform non-coherent detection for the secondary fast feedback channel in similar manner. The base station may also perform detection for the primary and secondary fast feedback channels in other manners.

FIG. 7 shows a design of a process 700 performed by a subscriber station or some other entity to send signaling. The subscriber station may determine (e.g., via an assignment message) time frequency resources comprising a first portion of time frequency resources for a first feedback channel and a second portion of time frequency resources for a second feedback channel (block 712). The first and second feedback channels may correspond to the primary and secondary fast feedback channels, respectively, in IEEE 802.16 or may be other feedback channels. The subscriber station may send signaling on the first feedback channel using the first portion of time frequency resources and/or on the second feedback channel using the second portion of time frequency resources (block 714).

The time frequency resources for the first and second feedback channels may comprise at least one tile (e.g., six tiles). Each tile may comprise at least one subcarrier in each of at least one symbol period. The first and second portions of time frequency resources may comprise first and second disjoint subsets of subcarriers, respectively, in each tile. In one design, each tile comprises four subcarriers in each of three symbol periods. The first portion of time frequency resources for the first feedback channel may comprise all subcarriers in each tile except for four subcarriers at four corners of each file, e.g., as shown in FIG. 5. The second portion of time frequency resources for the second feedback channel may comprise the four subcarriers at the four corners of each file, e.g., as shown in FIG. 5. The first and second portions of time frequency resources may also comprise other subsets of subcarriers in each tile.

In one design, the subscriber station may send signaling on the first feedback channel using the first portion of time frequency resources, and another subscriber station may use the second portion of time frequency resources. In another design, the subscriber station may send signaling on the second feedback channel using the second portion of time frequency resources, and another subscriber station may use the first portion of time frequency resources. In yet another design, the subscriber station may send signaling on the first feedback channel using the first portion of time frequency resources and also on the second feedback channel using the second portion of time frequency resources.

For block 714, the subscriber station may send vectors of modulation symbols of a first length (e.g., eight) on the first portion of time frequency resources for the first feedback channel. Alternatively or additionally, the subscriber station may send vectors of modulation symbols of a second length (e.g., four) on the second portion of time frequency resources for the second feedback channel.

FIG. 8 shows a design of an apparatus 800 for sending signaling. Apparatus 800 includes a module 812 to determine time frequency resources comprising a first portion of time frequency resources for a first feedback channel and a second portion of time frequency resources for a second feedback channel, and a module 814 to send signaling on the first feedback channel and/or the second feedback channel.

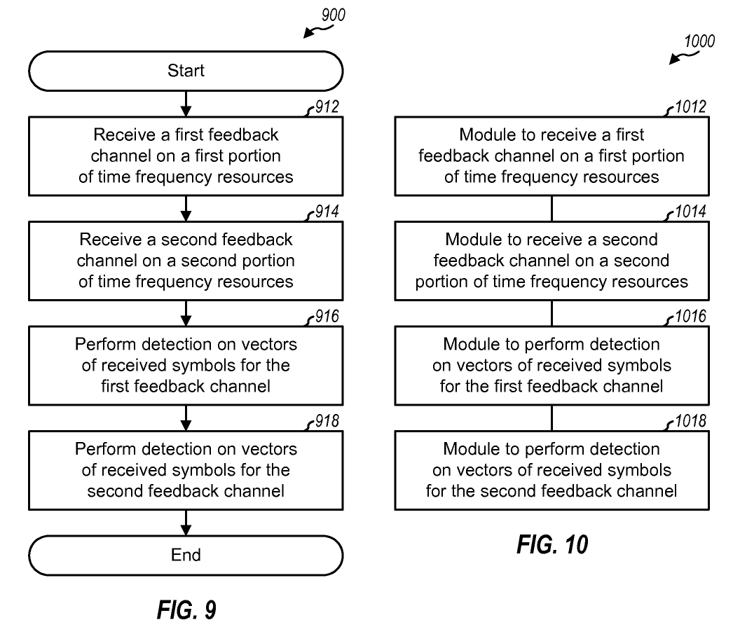

FIG. 9 shows a design of a process 900 performed by a base station or some other entity to receive signaling. The base station may receive a first feedback channel on a first portion of time frequency resources (block 912) and may receive a second feedback channel on a second portion of time frequency resources (block 914). The time frequency resources for the first and second feedback channels may comprise at least one tile, and each tile may comprise at least one subcarrier in each of at least one symbol period. The first and second portions of time frequency resources may comprise first and second disjoint subsets of subcarriers, respectively, in each tile. The first and second feedback channels may correspond to the primary and secondary fast feedback channels, respectively, in IEEE 802.16 or may be other feedback channels. The base station may receive the first and second feedback channels from a single subscriber station or from two subscriber stations.

For block 912, the base station may obtain vectors of received symbols of a first length (e.g., eight) for the first feedback channel. For block 914, the base station may obtain vectors of received symbols of a second length (e.g., four) for the second feedback channel. The base station may perform detection (e.g., non-coherent detection) on the vectors of received symbols for the first feedback channel based on a first set of vectors of modulation symbols (e.g., vectors v₀ through v₇) usable for the first feedback channel (block 916). The base station may perform detection on the vectors of received symbols for the second feedback channel based on a second set of vectors of modulation symbols (e.g., vectors w₀ through w₃) usable for the second feedback channel (block 918). In one design, for each feedback channel, the base station may perform detection for each tile and then determine a signaling message received on that feedback channel based on correlation results obtained for all tiles. In another design, for each feedback channel, the base station may perform detection across all tiles for each possible signaling message and then determine a message received on that feedback channel based on correlation results obtained for all possible messages.

FIG. 10 shows a design of an apparatus 1000 for receiving signaling. Apparatus 1000 includes a module 1012 to receive a first feedback channel on a first portion of time frequency resources, a module 1014 to receive a second feedback channel on a second portion of time frequency resources, a module 1016 to perform detection on vectors of received symbols for the first feedback channel, and a module 1018 to perform detection on vectors of received symbols for the second feedback channel.

The modules in FIGS. 8 and 10 may comprise processors, electronics devices, hardware devices, electronics components, logical circuits, memories, etc., or any combination thereof.

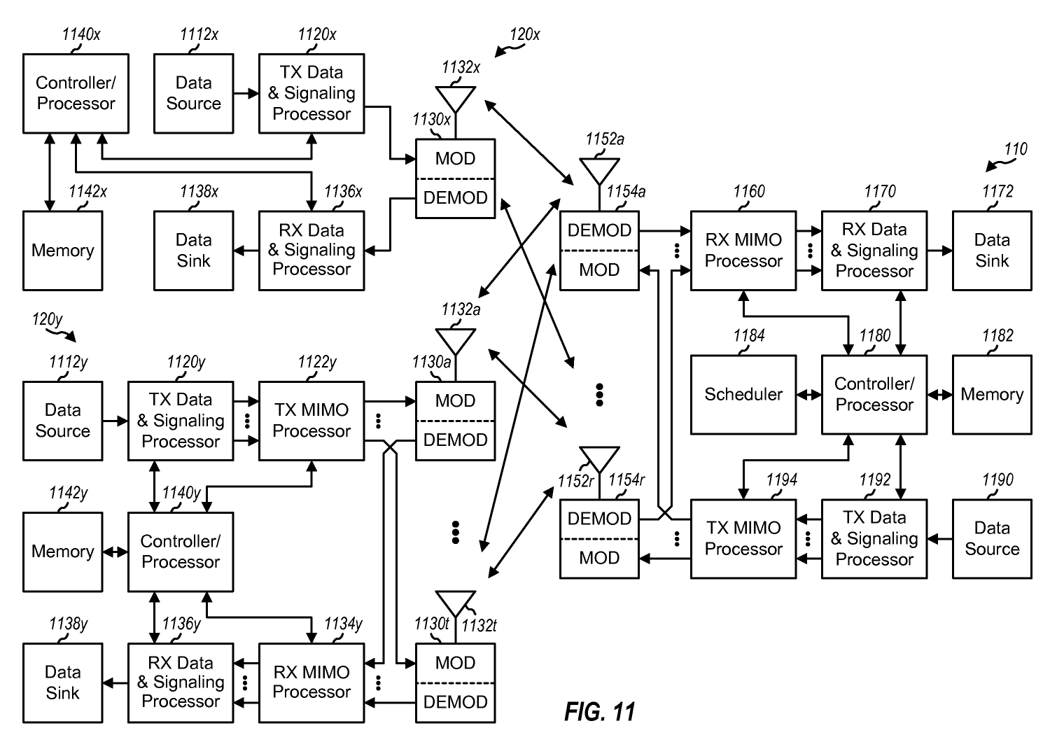

FIG. 11 shows a block diagram of a design of two subscriber stations 120x and 120y and a base station 110, which may be two of the subscriber stations and one of the base stations in FIG. 1. Subscriber station 120x is equipped with a single antenna 1132x, subscriber station 120y is equipped with multiple (T) antennas 1132a through 1132t, and base station 110 is equipped with multiple (R) antennas 1152a through 1152r. In general, the subscriber stations and base station may each be equipped with any number of antennas. Each antenna may be a physical antenna or an antenna array.

At each subscriber station 120, a transmit (TX) data and signaling processor 1120 receives data from a data source 1112, processes (e.g., formats, encodes, interleaves, and symbol maps) the data, and generates modulation symbols for data (or simply, data symbols). Processor 1120 also receives signaling (e.g., for the primary and/or secondary fast feedback channels) from a controller/processor 1140, processes the signaling, and generates modulation symbols for signaling (or simply, signaling symbols). Processor 1120 may also generate and multiplex pilot symbols with the data and signaling symbols.

At subscriber station 120y, a TX MIMO processor 1122y performs transmitter spatial processing on the data, signaling, and/or pilot symbols. Processor 1122y may perform direct MIMO mapping, preceding, beamforming, etc. A symbol may be sent from one antenna for direct MIMO mapping or from multiple antennas for precoding and beamforming. Processor 1122y provides T output symbol streams to T modulators (MODs) 1130a through 1130t. At subscriber station 120x, processor 1120x provides a single output symbol stream to a modulator 1130x. Each modulator 1130 may perform modulation (e.g., for OFDM) on the output symbols to obtain output chips. Each modulator 1130 further processes (e.g., converts to analog, filters, amplifies, and upconverts) its output chips and generates an uplink signal. At subscriber station 120x, a single uplink signal from modulator 1130x is transmitted via antenna 1132x. At subscriber station 120y, T uplink signals from modulators 1130a through 1130t are transmitted via T antennas 1132a through 1132t, respectively.

At base station 110, R antennas 1152a through 1152r receive the uplink signals from subscriber stations 120x and 120y and possibly other subscriber stations. Each antenna 1152 provides a received signal to a respective demodulator (DEMOD) 1154. Each demodulator 1154 processes (e.g., filters, amplifies, downconverts, and digitizes) its received signal to obtain samples. Each demodulator 1154 may also perform demodulation (e.g., for OFDM) on the samples to obtain received symbols. A receive (RX) MIMO processor 1160 may estimate the channel responses for different subscriber stations based on received pilot symbols, performs MIMO detection on received data symbols, and provides data symbol estimates. An RX data and signaling processor 1170 then processes (e.g., symbol demaps, deinterleaves, and decodes) the data symbol estimates and provides decoded data to a data sink 1172. Processor 1170 also performs detection on the received signaling symbols for the primary and secondary fast feedback channels and provides detected signaling to a controller/processor 1180.

Base station 110 may send data and signaling to the subscriber stations. Data from a data source 1190 and signaling from controller/processor 1180 may be processed by a TX data and signaling processor 1192, further processed by a TX MIMO processor 1194, and then processed by modulators 1154a through 1154r to generate R downlink signals, which may be sent via R antennas 1152a through 1152r. At each subscriber station 1110, the downlink signals from base station 110 may be received by one or more antennas 1132 and processed by one or more demodulators 1130 to obtain received symbols. At subscriber station 120x, the received symbols may be processed by an RX data and signaling processor 1136x to recover the data and signaling sent by base station 110 for subscriber station 120x. At subscriber station 120y, the received symbols may be processed by an RX MIMO processor 1134y and further processed by an RX data and signaling processor 1136y to recover the data and signaling sent by base station 110 for subscriber station 120y.

Controllers/processors 1140x, 1140y, and 1180 may control the operation of various processing units at subscriber stations 120x and 120y and base station 110, respectively. Controllers/processors 1140x and 1140y may perform or direct process 700 in FIG. 7 and/or other processes for the techniques described herein. Controller/processor 1180 may perform or direct process 900 in FIG. 9 and/or other processes for the techniques described herein. Memories 1142x, 1142y, and 1182 may store data and program codes for subscriber stations 120x and 120y and base station 110, respectively. A scheduler 1184 may schedule the subscriber stations for transmission on the downlink and/or uplink.

The techniques described herein may be implemented by various means. For example, these techniques may be implemented in hardware, firmware, software, or a combination thereof. For a hardware implementation, the processing units at each entity (e.g., a subscriber station or a base station) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

For a firmware and/or software implementation, the techniques may be implemented with modules (e.g., procedures, functions, etc.) that perform the functions described herein. The firmware and/or software instructions may be stored in a memory (e.g., memory 1142x, 1142y, or 1182 in FIG. 11) and executed by a processor (e.g., processor 1140x, 1140y, or 1180). The memory may be implemented within the processor or external to the processor. The firmware and/or software instructions may also be stored in other processor-readable medium such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, etc.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus for wireless communication, comprising:
at least one processor configured to determine time frequency resources comprising a first portion of time frequency resources for a first feedback channel and a second portion of time frequency resources for a second feedback channel, and to send signaling on the first feedback channel, or the second feedback channel, or both the first and second feedback channels, wherein the time frequency resources comprise at least one tile, each tile comprising at least one subcarrier in each of at least one symbol period, and wherein the first and second portions of time frequency resources comprise first and second disjoint subsets of subcarriers, respectively, in each of the at least one tile; and
a memory coupled to the at least one processor.

2. The apparatus of claim 1, wherein the time frequency resources comprise six tiles, each tile comprising four subcarriers in each of three symbol periods.

3. The apparatus of claim 2, wherein the first portion of time frequency resources comprises all subcarriers in each tile except for four subcarriers at four corners of each file, and wherein the second portion of time frequency resources comprises the four subcarriers at the four corners of each file.

4. The apparatus of claim 1, wherein the at least one processor is configured to send signaling on the first feedback channel using the first portion of time frequency resources, and wherein the second portion of time frequency resources is used by another subscriber station.

5. The apparatus of claim 1, wherein the at least one processor is configured to send signaling on the second feedback channel using the second portion of time frequency resources, and wherein the first portion of time frequency resources is used by another subscriber station.

6. The apparatus of claim 1, wherein the at least one processor is configured to send signaling on the first feedback channel using the first portion of time frequency resources and on the second feedback channel using the second portion of time frequency resources.

7. The apparatus of claim 1, wherein to send signaling on the first feedback channel the at least one processor is configured to send vectors of modulation symbols of a first length on the first portion of time frequency resources.

8. The apparatus of claim 7, wherein to send signaling on the second feedback channel the at least one processor is configured to send vectors of modulation symbols of a second length on the second portion of time frequency resources.

9. The apparatus of claim 1, wherein the first and second feedback channels correspond to primary and secondary fast feedback channels in IEEE 802.16.

10. A method for wireless communication, comprising:
determining time frequency resources comprising a first portion of time frequency resources for a first feedback channel and a second portion of time frequency resources for a second feedback channel, the time frequency resources comprising at least one tile, each tile comprising at least one subcarrier in each of at least one symbol period, the first and second portions of time frequency resources comprising first and second disjoint subsets of subcarriers, respectively, in each of the at least one tile; and
sending signaling on the first feedback channel, or the second feedback channel, or both the first and second feedback channels.

11. The method of claim 10, wherein the sending signaling comprises sending vectors of modulation symbols of a first length on the first portion of time frequency resources.

12. The method of claim 11, wherein the sending signaling further comprises sending vectors of modulation symbols of a second length on the second portion of time frequency resources.

13. An apparatus for wireless communication, comprising:
means for determining time frequency resources comprising a first portion of time frequency resources for a first feedback channel and a second portion of time frequency resources for a second feedback channel, the time frequency resources comprising at least one tile, each tile comprising at least one subcarrier in each of at least one symbol period, the first and second portions of time frequency resources comprising first and second disjoint subsets of subcarriers, respectively, in each of the at least one tile; and
means for sending signaling on the first feedback channel, or the second feedback channel, or both the first and second feedback channels.

14. The apparatus of claim 13, wherein the means for sending signaling comprises means for sending vectors of modulation symbols of a first length on the first portion of time frequency resources.

15. The apparatus of claim 14, wherein the means for sending signaling further comprises means for sending vectors of modulation symbols of a second length on the second portion of time frequency resources.

16. A processor-readable medium including instructions stored thereon, comprising:
a first instruction set for determining time frequency resources comprising a first portion of time frequency resources for a first feedback channel and a second portion of time frequency resources for a second feedback channel, the time frequency resources comprising at least one tile, each tile comprising at least one subcarrier in each of at least one symbol period, the first and second portions of time frequency resources comprising first and second disjoint subsets of subcarriers, respectively, in each of the at least one tile; and
a second instruction set for sending signaling on the first feedback channel, or the second feedback channel, or both the first and second feedback channels.

17. The processor-readable media of claim 16, wherein the second instruction set comprises a third instruction set for sending vectors of modulation symbols of a first length on the first portion of time frequency resources.

18. The processor-readable media of claim 17, wherein the second instruction set further comprises a fourth instruction set for sending vectors of modulation symbols of a second length on the second portion of time frequency resources.

19. An apparatus comprising:
at least one processor configured to receive a first feedback channel on a first portion of time frequency resources, and to receive a second feedback channel on a second portion of time frequency resources, wherein time frequency resources for the first and second feedback channels comprise at least one tile, each tile comprising at least one subcarrier in each of at least one symbol period, and wherein the first and second portions of time frequency resources comprise first and second disjoint subsets of subcarriers, respectively, in each of the at least one tile; and
a memory coupled to the at least one processor.

20. The apparatus of claim 19, wherein the time frequency resources for the first and second feedback channels comprise six tiles, each tile comprising four subcarriers in each of three symbol periods.

21. The apparatus of claim 20, wherein the first portion of time frequency resources for the first feedback channel comprises all subcarriers in each tile except for four subcarriers at four corners of each file, and wherein the second portion of time frequency resources for the second feedback channel comprises the four subcarriers at the four corners of each file.

22. The apparatus of claim 19, wherein the at least one processor is configured to receive the first and second feedback channels from a single subscriber station.

23. The apparatus of claim 19, wherein the at least one processor is configured to receive the first and second feedback channels from two subscriber stations.

24. The apparatus of claim 19, wherein the at least one processor is configured to obtain vectors of received symbols of a first length for the first feedback channel, and to obtain vectors of received symbols of a second length for the second feedback channel.

25. The apparatus of claim 19, wherein the at least one processor is configured to perform detection on vectors of received symbols for the first feedback channel based on a first set of vectors of modulation symbols usable for the first feedback channel.

26. The apparatus of claim 25, wherein the at least one processor is configured to perform detection on vectors of received symbols for the second feedback channel based on a second set of vectors of modulation symbols usable for the second feedback channel.

27. A method comprising:
receiving a first feedback channel on a first portion of time frequency resources; and
receiving a second feedback channel on a second portion of time frequency resources, wherein time frequency resources for the first and second feedback channels comprise at least one tile, each tile comprising at least one subcarrier in each of at least one symbol period, and wherein the first and second portions of time frequency resources comprise first and second disjoint subsets of subcarriers, respectively, in each of the at least one tile.

28. The method of claim 27, wherein the first and second feedback channels are received from a single subscriber station.

29. The method of claim 27, wherein the first and second feedback channels are received from two subscriber stations.

30. The method of claim 27, wherein the receiving the first feedback channel comprises obtaining vectors of received symbols of a first length for the first feedback channel, and wherein the receiving the second feedback channel comprises obtaining vectors of received symbols of a second length for the second feedback channel.

31. The method of claim 27, further comprising:
performing detection on vectors of received symbols for the first feedback channel based on a first set of vectors of modulation symbols usable for the first feedback channel; and
performing detection on vectors of received symbols for the second feedback channel based on a second set of vectors of modulation symbols usable for the second feedback channel.

32. An apparatus comprising:
means for receiving a first feedback channel on a first portion of time frequency resources; and
means for receiving a second feedback channel on a second portion of time frequency resources, wherein time frequency resources for the first and second feedback channels comprise at least one tile, each tile comprising at least one subcarrier in each of at least one symbol period, and wherein the first and second portions of time frequency resources comprise first and second disjoint subsets of subcarriers, respectively, in each of the at least one tile.

33. The apparatus of claim 32, wherein the means for receiving the first feedback channel comprises means for obtaining vectors of received symbols of a first length for the first feedback channel, and wherein the means for receiving the second feedback channel comprises means for obtaining vectors of received symbols of a second length for the second feedback channel.

34. The apparatus of claim 32, further comprising:
means for performing detection on vectors of received symbols for the first feedback channel based on a first set of vectors of modulation symbols usable for the first feedback channel; and
means for performing detection on vectors of received symbols for the second feedback channel based on a second set of vectors of modulation symbols usable for the second feedback channel.

35. A processor-readable medium including instructions stored thereon, comprising:
a first instruction set for receiving a first feedback channel on a first portion of time frequency resources; and
a second instruction set for receiving a second feedback channel on a second portion of time frequency resources, wherein time frequency resources for the first and second feedback channels comprise at least one tile, each tile comprising at least one subcarrier in each of at least one symbol period, and wherein the first and second portions of time frequency resources comprise first and second disjoint subsets of subcarriers, respectively, in each of the at least one tile.

36. The processor-readable medium of claim 35, wherein the first instruction set comprises a third instruction set for obtaining vectors of received symbols of a first length for the first feedback channel, and wherein the second instruction set comprises a fourth instruction set for obtaining vectors of received symbols of a second length for the second feedback channel.

37. The processor-readable medium of claim 35, further comprising:
a third instruction set for performing detection on vectors of received symbols for the first feedback channel based on a first set of vectors of modulation symbols usable for the first feedback channel; and
a fourth instruction set for performing detection on vectors of received symbols for the second feedback channel based on a second set of vectors of modulation symbols usable for the second feedback channel.
